(19) United States
(12) Patent Application Publication
(10) Pub. No.: US 2005/0105973 A1
(43) Pub. Date: May 19, 2005

(54) Variable flute helical-pitch rotary cutting tool

(75) Inventor: Mike MacArthur, Auburn, CA (US)

Correspondence Address: James M. Ritchey;O'BANION & RITCHEY, Wells Fargo Center, Suite 1550, 400 Capitol Mall, Sacramento, CA, 95814, US

(73) Assignee: Robbjack Corporation, Lincoln, CA (US)

(21) Appl. No.: 10/717,240

(22) Filed: Nov. 18, 2003

(51) Int. Cl. B23C 5/10

(52) U.S. Cl. 407/53

(57) ABSTRACT

An rotary cutting tool is presented that has a shank region, a cutting region terminating in a cutting tip, at least one a flute formed within the cutting region beginning at the cutting tip and terminating at a distal location towards the shank region, and a cutting edge formed along an outer border of each flute. Each flute starts with a first helical-pitch proximate the cutting tip and changes to a second helical-pitch proximate the terminating distal location. When the rotary cutting tool has multiple paired flutes each set of paired flutes may be off-set from the next at other than a perpendicular alignment.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to a rotary cutting tool having at least one variable helical-pitch or helical-angle cutting flute. In particular, the subject invention discloses an rotary cutting tool having improved harmonic resonance stability characteristics produced by incorporating at least one cutting flute that begin at the end mill cutting tip with a first helical-pitch and gradually varies to a terminating second helical-pitch and when a plurality of paired flutes are present both variable helical-pitch and off-set spacing of the paired flutes minimizes vibrations.

2. Description of Related Art

Rotary cutting tools or end mill tools have been utilized for various cutting duties over many years. When a traditionally designed and sharpened end mill tool, frequently composed of carbide and carbide alloys, rotationally encounters a substance like aluminum or the like, the mill begins to “chatter,” whereby the rotating end mill's frequency of vibration (resonance frequency) self-excites and causes a poor finish on the machined part. The self-exciting chatter is usually accompanied by a loud noise while machining. The self-exciting chatter has been an inherent characteristic of long diameter to length cutting tools. In addition to the poor finish associated with the traditional chatter-producing end mill is a limitation with thin-walled aluminum parts. The end mill tool chatter may stress the thin-walled aluminum parts beyond structural limits and produce unacceptable parts. Further, chattering can dull the cutting edge of an end mill and limit its useful life, thereby increasing costs for the milling operation and generating less precise machined parts than may be desired or required for a particular final function.

Further, a rotary cutting tool typically has one or more equally spaced helical flutes spaced about the periphery of the tool which are sharpened to form the cutting edges, The helical angle of each flute is the same from the cutting tip to its termination. In some rotary cutting tools the helical angle of one flute may be different from the helical angle of another flute, but each flute has the same helical angle from its start to termination. Some existing end mill tools have the flutes spaced at un-equal positions to decrease vibrations.

U.S. Pat. No. 4,963,059 discloses a rotary cutting tool in which a plurality of peripheral cutting flutes exist, wherein each flute has a fixed helical-pitch. The invention relates to the improvement that at least one of the plurality of peripheral cutting helical flutes has a different fixed helical-pitch than the other fixed helical-pitch flutes on the tool.

Depicted in U.S. Pat. No. 4,285,618 is a rotary milling cutter. Multiple cutting flutes are incorporated into the tool with each one having a combination of both smooth and serrated segments.

A variable diameter rotary cutting tool is presented in U.S. Pat. No. 6,164,877. Each cutting flute is at a constant helical-pitch and have a predetermined clearance angle that is constant in the axial direction, irrespective of the change of the diameter.

U.S. Pat. No. 6,258,093 describes a surgical reamer cutter having a plurality of flutes, wherein each flute may have its own fixed helical angle and each flute may have a different fixed helical angle from any other flute. One or more teeth are positioned along each cutting flute.

U.S. Pat. No. 5,222,847 relates a typical tap for forming threads inside a suitable aperture. A plurality of serrated helical cutting edges cover the outer circumference of the tap.

A roughing cutter is described in U.S. Pat. No. 4,083,643. Comprising the roughing cutter are a plurality of angular flutes separated by a plurality of lands. A plurality of cutting teeth are formed in each flute, wherein each tooth has a straight cutting edge generally perpendicular to the radial direction.

U.S. Pat. Nos. 6,179,528 and 6,439,811 display an end mill tool with both high and low flutes. At least one first flute is included that defines a low-angle cutting surface and at least one second flute is included that defines a high-angle cutting surface.

An end mill tool with multiple cutting edges is outlined in U.S. Pat. No. 6,168,355. Cutting flutes spiral down the tool and end at the tool's point. The point of the tool includes additional cutting edges.

The foregoing patents reflect the state of the art of which the applicant is aware and are tendered with the view toward discharging applicant's acknowledged duty of candor in disclosing information which may be pertinent in the examination of this application. It is respectfully submitted, however, that none of these patents teach or render obvious, singly or when considered in combination, applicant's claimed invention.

### BRIEF SUMMARY OF THE INVENTION

An object of the present invention is to provide a rotary cutting tool that reduces chatter or resonance vibrations during usage, thereby producing better finishes on milled parts.

Another object of the present invention is to furnish a rotary cutting tool having at least one cutting flute having a variable helical-pitch or helical-angle from the cutting tip to its termination position.

A further object of the present invention is to supply a rotary cutting tool having a plurality of cutting flutes with each cutting flute having a variable helical-pitch from the cutting tip to its termination position.

Yet another object of the present invention is to describe a rotary cutting tool having a plurality of cutting flutes, each cutting flute having a variable helical-pitch from the cutting tip to its termination position, wherein the positioning of the flutes is uneven about the tool.

Still another object of the present invention is to disclose a rotary cutting tool having a plurality of paired cutting flutes with each pair having the same variable helical-pitch from the cutting tip to its termination position, wherein the positioning of each set of paired flutes may be off-set from the next set at other than a perpendicular alignment.

Disclosed is a rotary cutting or end mill tool comprising a shank, a cutting region terminating in a cutting tip, at least one a flute formed within the cutting region beginning at the cutting tip and terminating at a distal location towards the shank, and a cutting edge formed along an outer border of each flute. Each flute starts with a first helical-pitch or helical-angle (referenced to a central axis extending the length of the tool) proximate the cutting tip and changes to a second helical-pitch proximate the terminating distal location (i.e.: 10° at the cutting tip and 60° towards the shank and the reverse with 60° at the cutting tip and 10° towards the shank are acceptable with any combination of helical angles within this range being common). When the rotary cutting tool has multiple flutes each flute may be off-set from the next at other than evenly spaced alignments and when the rotary cutting tool has multiple paired flutes each set of paired flutes may be off-set from the next at other than a perpendicular alignment.

A major advantage of the subject rotary cutting tool is that it can remove more material at a faster feed rate that typical rotary cutting tools. The subject cutting tool is able to cut at faster revolutions per minute and faster feed rates without running into unstable cutting conditions. One reason for this is that the harmonic resonance is reduced. The frequency that is produced at a certain point of contact with the cutting edge changes as the helical-pitch changes. As the next cutting edge comes around and makes contact with the material it has a different frequency and that too changes as it rotates, thus reducing the harmonic resonance that normally is produced with traditional rotary cutting tools. Off-setting the flutes also aids in reducing resonance vibrations.

Further objects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 shows a side view of a first embodiment of the subject rotary cutting tool, wherein the tool has two variable helical-pitch cutting flutes.

FIG. 2 shows a side view of a second embodiment of the subject rotary cutting tool, wherein the tool has four variable helical-pitch cutting flutes with one of the paired sets of variable helical-pitch flutes off-set from the second paired set of variable helical-pitch flutes.

FIG. 3 shows the second embodiment of the subject rotary cutting tool and pointing out that variable helical-pitch flute 1 has a helical pitch that starts at 35° at the cutting tip and changes to 38° towards the shank while variable helical-pitch flute 4 has a helical pitch that starts at 38° at the cutting tip and changes to 35° towards the shank.

FIG. 4 is an end view of the second embodiment of the subject cutting tool showing a first set of paired flutes that are off-set from a second set of paired flutes.

FIG. 5A shows the gradual change in helical-pitch of flute 1 from FIG. 3 from 35° at the cutting tip to 38° towards the shank.

FIG. 5B show the gradual change in helical-pitch of flute 4 from FIG. 3 from 38° at the cutting tip to 35° towards the shank

### DETAILED DESCRIPTION OF THE INVENTION

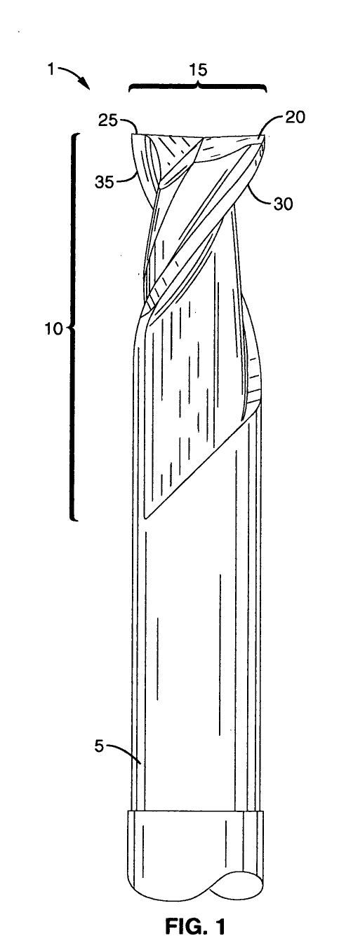

Referring more specifically to the drawings, for illustrative purposes the present invention is embodied in the apparatus generally shown in FIG. 1 through FIGS. 5A and 5B. It will be appreciated that the apparatus may vary as to configuration and as to details of the parts, and that the method may vary as to the specific steps and sequence, without departing from the basic concepts as disclosed herein.

Many rotary cutting tools are fabricated from various commercial grades of solid carbide and carbide alloy and are designed to machine parts formed from softer aluminum to harder stainless steels and related alloys. The subject invention is particularly useful in machining such parts where deep pockets and thin walls are encountered.

Generally, each rotary cutting tool comprises a shank, sometimes transitioning into a narrower neck (the machine utilizing the rotary cutting tool grips the tool by the shank). The shank extends to a cutting region with the cutting region terminating in a cutting tip. One or more flutes are formed within the cutting region beginning at the cutting tip and terminating at a distal location towards the shank. A cutting edge is formed along an outer border of each flute. The number of flutes may vary, usually from one to six or more and the flutes may be paired with one other identical flute or matched with one or more other identical flutes. For exemplary purposes only and not by way of limitation, both two flute and four flute configurations are described below in detail, but, as indicated this is not limiting and other numbers of flutes are considered to be within the realm of this disclosure.

With more specificity, a first preferred embodiment of a rotary cutting tool 1 (having two flutes) is shown in FIG. 1 and comprises a shank transitioning into a neck 5, a cutting region 10, a cutting tip 15, a first variable helical-pitch flute 20, a second variable helical-pitch flute 25, a first cutting edge 30 (running along the outer perimeter of first flute 20), and a second cutting edge 35 (running along the outer perimeter of second flute 25). Each variable helical-pitch flute 20 and 25 begins at the cutting tip 15 with a first helical-pitch and varies to end with a second helical-pitch towards the shank or neck 5. The helical-pitch of each flute varies from a larger angle to a smaller angle (the angle being determined from the long axis of the tool) or visa versa with the first flute 20 normally having the helical-pitch angle running opposite of the second flute 25. Suitable ranges for the helical-pitch gradual changes generally extend from about 10° to 60° or 60° to 10° and further to such ranges as 30° to 40° or 40° to 30° and 35° to 38° or 38° to 35° and 30° to 35° or 35° to 30° and equivalent ranges. Clearly, for a variable helical-pitch range to exist the first helical-pitch and the second helical-pitches do not equal one another.

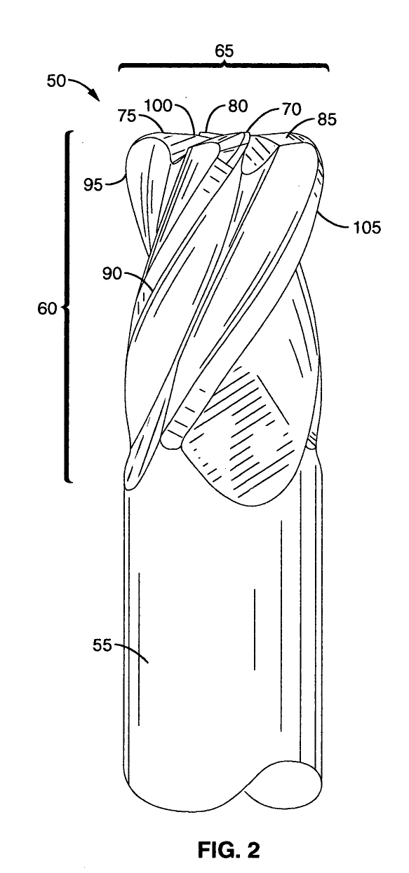

A second preferred embodiment of a rotary cutting tool 50 (having four flutes) is shown in FIG. 2 and comprises a shank 55 (with no narrower neck in this particular tool), a cutting region 60, a cutting tip 65, a first variable helical-pitch flute 70, a second variable helical-pitch flute 75, a third variable helical-pitch flute 80, a forth variable helical-pitch flute 85 a first cutting edge 90 (running along the outer perimeter of first flute 70), a second cutting edge 95 (running along the outer perimeter of second flute 75), a third cutting edge 100 (running along the outer perimeter of third flute 80), and a forth cutting edge 105 (running along the outer perimeter of forth flute 85).

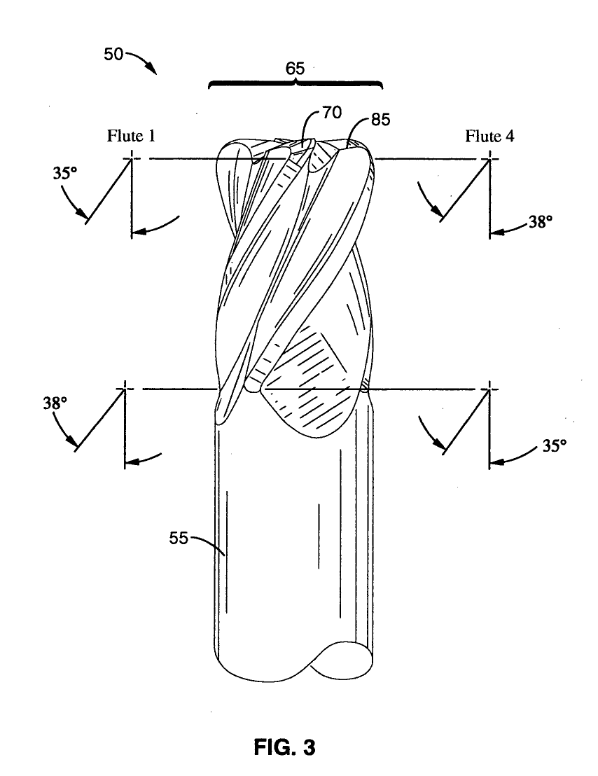

FIG. 3 shows that in the second embodiment of the subject invention that the helical-pitch of the first flute 70 (labeled Flute 1) begins at the cutting tip 65 with a helical-pitch of about 35° and varies to end proximate the shank at a helical-pitch of about 38°, whereas the forth flute 85 (labeled Flute 4) varies in the opposite way from a helical-pitch of about 38° and to end proximate the shank at a helical-pitch of about 35°. As indicated above, the particular helical-pitch range cited here is for exemplary purposes only and not by way of limitation.

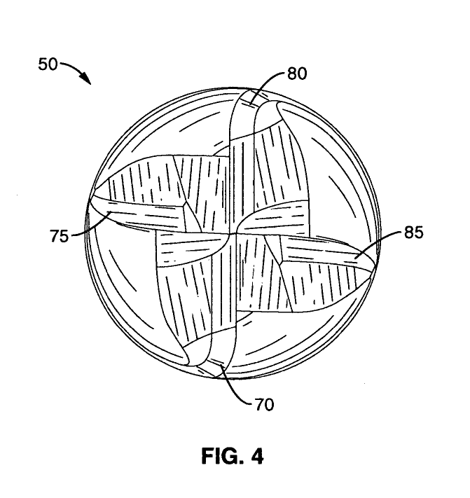

FIG. 4 shows the cutting tip of the second embodiment of the subject invention and clearly presents the alignments for the four flutes 70, 75, 80, and 85. The first flute 70 and the third flute 80 are directly across from one another and the second flute 75 and the forth flute 85 are directly across from one another, but the first-third pair of flutes 70 and 80 are off-set from the second-forth pair of flutes 75 and 85. The off-set amount may vary but is usually between about 1° to 10° and more often between about 3° to 8°.

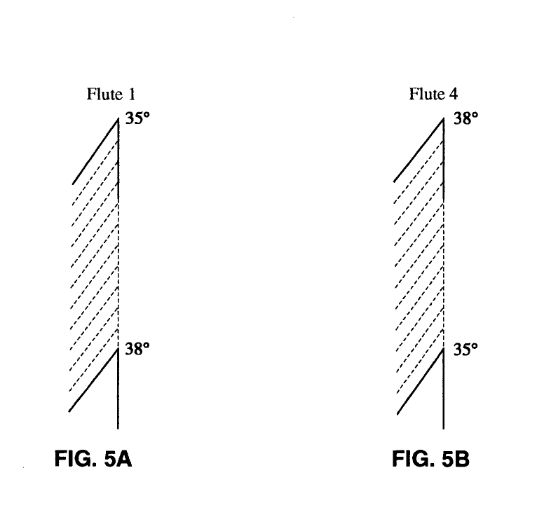

FIGS. 5A and 5B illustrate, in more detail, the variable helical-pitch found in the second embodiment tool first flute 70 and the forth flute 85. In FIG. 5A it is plainly seen that the helical-pitch begins at 35° at the cutting tip and gradually changes to 38° towards the shank. In FIG. 5B the opposite is seen with the helical-pitch beginning at 38° at the cutting tip and gradually changing to 35° towards the shank.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A rotary cutting tool having a shank that extends to a cutting region, the cutting region terminates in a cutting tip, a flute formed within the cutting region begins at the cutting tip and terminates at a distal location towards the shank, and a cutting edge formed along an outer border of the flute, wherein said flute comprises:
a) a first helical-pitch proximate the cutting tip and
b) a second helical-pitch proximate the terminating distal location with a gradual transition of said flute from said first helical-pitch to said second helical-pitch.

2. A rotary cutting tool according to claim 1, wherein said first helical-pitch is about 10° to about 60°, said second helical-pitch is from about 60° to about 10° and said first and said second helical-pitches do not equal one another.

3. A rotary cutting tool according to claim 1, wherein said first helical-pitch is about 30° to about 40°, said second helical-pitch is from about 40° to about 30° and said first and said second helical-pitches do not equal one another.

4. A rotary cutting tool having a shank that extends to a cutting region, the cutting region terminates in a cutting tip, a plurality of flutes formed within the cutting region with each flute beginning at the cutting tip and terminating at a distal location towards the shank, and a cutting edge formed along an outer border of each flute, wherein each said flute comprises:
a) a first helical-pitch proximate the cutting tip and
b) a second helical-pitch proximate the terminating distal location with a gradual transition of said flute from said first helical-pitch to said second helical-pitch.

5. A rotary cutting tool according to claim 4, wherein each flute has said first helical-pitch is about 10° to about 60°, said second helical-pitch is from about 60° to about 10° and said first and said second helical-pitches do not equal one another.

6. A rotary cutting tool according to claim 4, wherein each said flute has said first helical-pitch is about 30° to about 40°, said second helical-pitch is from about 40° to about 30° and said first and said second helical-pitches do not equal one another.

7. A rotary cutting tool according to claim 4, wherein each adjacent flute has said first and said second helical-pitches reversed with said first helical-pitch about 10° to about 60°, said second helical-pitch from about 60° to about 10° and said first and said second helical-pitches do not equal one another.

8. A rotary cutting tool according to claim 4, wherein each adjacent flute has said first and said second helical-pitches reversed with said first helical-pitch about 30° to about 40°, said second helical-pitch from about 40° to about 30° and said first and said second helical-pitches do not equal one another.

9. A rotary cutting tool having a shank that extends to a cutting region, the cutting region terminates in a cutting tip, a plurality of paired flutes formed within the cutting region with each flute having a variable helical-pitch and beginning at the cutting tip and terminating at a distal location towards the shank, and a cutting edge formed along an outer border of each flute, wherein for each pair of flutes each said flute within the pair has an identical variable helical-pitch and comprises:
a) a first helical-pitch proximate the cutting tip and
b) a second helical-pitch proximate the terminating distal location with a gradual transition of said flute from said first helical-pitch to said second helical-pitch.

10. A rotary cutting tool according to claim 9, wherein each flute has said first helical-pitch from about 10° to about 60°, said second helical-pitch from about 60° to about 10° and said first and said second helical-pitches do not equal one another.

11. A rotary cutting tool according to claim 9, wherein each said flute has said first helical-pitch about 30° to about 40°, said second helical-pitch from about 40° to about 30° and said first and said second helical-pitches do not equal one another.

12. A rotary cutting tool according to claim 9, wherein each adjacent flute has said first and said second helical-pitches reversed with said first helical-pitch about 10° to about 60°, said second helical-pitch from about 60° to about 10° and said first and said second helical-pitches do not equal one another.

13. A rotary cutting tool according to claim 9, wherein each adjacent flute has said first and said second helical-pitches reversed with said first helical-pitch about 30° to about 40°, said second helical-pitch from about 40° to about 30° and said first and said second helical-pitches do not equal one another.

14. A rotary cutting tool according to claim 9, wherein each said flute within a pair of flutes is aligned directly across from one another and each pair of flutes is off-set from any other pair of flutes by between about 1° to about 10°.
